(19) United States
(12) Patent Application Publication
(10) Pub. No.: US 2015/0319414 A1
(43) Pub. Date: Nov. 5, 2015

(54) METHOD FOR CONTROLLING AN ALTERNATIVE USER INTERFACE IN A DEVICE

(71) Applicant: SYMBOL TECHNOLOGIES, INC., Schaumburg, IL (US)

(72) Inventors: Paul D. Haist, Toronto (CA); Scott A. Arnold, Etobicoke (CA); Graham G. Marshall, Shoreham, NY (US); Konstantinos D. Tsiopanos, Selden, NY (US)

(73) Assignee: SYMBOL TECHNOLOGIES, INC., Schaumburg, IL (US)

(21) Appl. No.: 14/269,614

(22) Filed: May 5, 2014

(51) Int. Cl. H04N 9/31; G06F 3/0484

(52) U.S. Cl. CPC H04N 9/31; G06F 3/04847; G06F 3/04842

(57) ABSTRACT

A method for controlling an alternative motion-based user interface in a device comprising a projector is provided. The method comprises receiving, at the device, an input comprising an instruction to switch from a previous user interface to the alternative user interface. The device then generates an image containing a plurality of selectable elements and a pointing element, and projects the image on a surface with the projector. The device detects a movement of the device, and updates the image to stabilize the plurality of selectable elements against the detected movement and to track the detected movement with the pointing element. The device projects the updated image on the surface, and selects one of the selectable elements based on a motion vector of the pointing element relative to the selectable elements. The device performs an action corresponding to the selected one of the selectable elements.

### BACKGROUND OF THE INVENTION

Enterprise workflows, such as those related to inventory management, are often optimized to reduce the time required by users to perform various tasks. Such tasks may include, for example, scanning inventory with a device such as a mobile computer equipped with an optical scanner, prior to shipping the inventory to another location. When a workflow includes alternative paths rather than a single sequential path, the user may be required to stop the current flow of operation, i.e. scanning and moving items, and then manipulate the device to locate the appropriate menu or field in an interface provided by the device, in order to activate the appropriate alternative path.

The above scenario may result in an undesirably long interruption to the optimized scanning and shipping workflow. Accordingly, there is a need for a method for controlling an alternative user interface in such devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a device in accordance with some embodiments.

FIG. 2 represents a flowchart of a method of controlling an alternative motion-based user interface in accordance with some embodiments.

FIGS. 3A, 3B and 3C illustrate examples of an image generated and outputted during the method of FIG. 2 in accordance with some embodiments.

FIGS. 4A, 4B and 4C illustrate examples of an updated image generated and outputted during the method of FIG. 2 in accordance with some embodiments.

FIGS. 5A, 5B and 5C illustrate examples of selection of a selectable element in the updated image of FIGS. 4A, 4B and 4C generated and outputted during the method of FIG. 2 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A method for controlling an alternative motion-based user interface in a device comprising a projector is provided. The method comprises receiving, at the device, an input comprising an instruction to switch from a previous user interface to the alternative user interface. The device then generates an image containing a plurality of selectable elements and a pointing element, and projects the image on a surface with the projector. The device detects a movement of the device, and updates the image to stabilize the plurality of selectable elements against the detected movement and to track the detected movement with the pointing element. The device projects the updated image on the surface, and selects one of the selectable elements based on a motion vector of the pointing element relative to the selectable elements. The device performs an action corresponding to the selected one of the selectable elements.

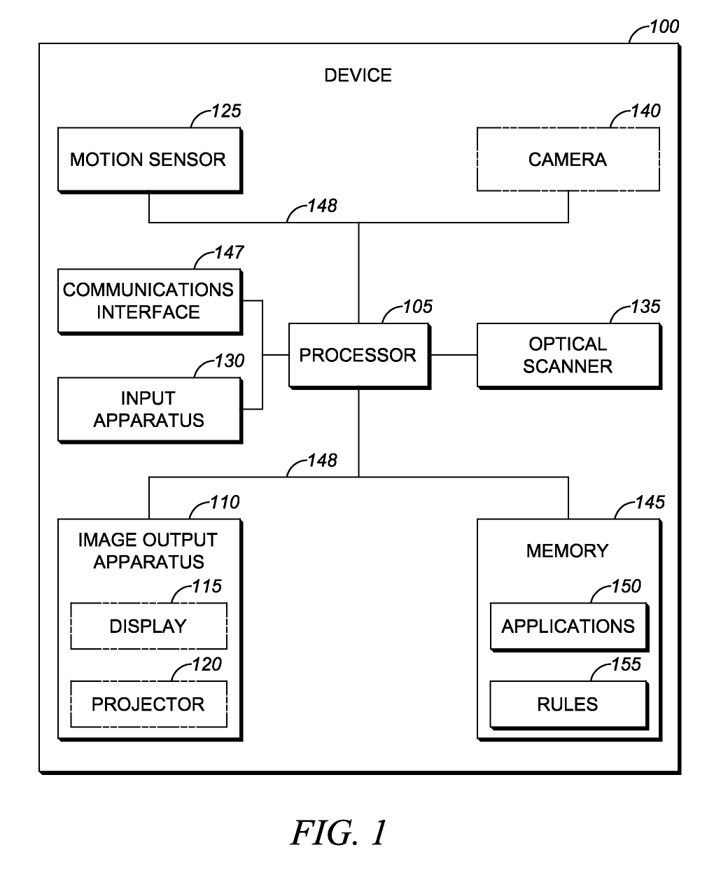

FIG. 1 is a block diagram of a device 100 in which methods and components for controlling an alternative motion-based user interface are implemented in accordance with the embodiments. The device 100 may take the form of, but is not limited to, a peripheral coupled to a desktop computer, handheld devices such as a cellular telephone, smart telephone, tablet, mobile computer, personal digital assistant and the like, two-way radio, a laptop or notebook computer, and the like. Embodiments may be advantageously implemented to receive user input at the device 100 while minimizing interruptions to existing workflows in which the device 100 is employed. Embodiments may be implemented in any electronic device receiving user input associated with images presented by such electronic device.

The device 100 comprises a processor 105, an image output apparatus 110 comprising at least one of a display 115 and a projector 120, a motion sensor 125, an input apparatus 130, an optical scanner 135, optionally a camera 140, and a memory 145. The device 100 may also comprise a communications interface 147. The components of the device 100 are connected by one or more communication buses 148 (e.g. Universal Serial Bus (USB), Peripheral Component Interconnect (PCI) and the like) that carry data between the components. While FIG. 1 shows the communication buses 148 connecting the processor 105 to each of the remaining components of the device 100, in some embodiments components other than the processor 105 may be connected directly to one another, in addition to or instead of being connected to the processor 105. The processor 105 runs or executes operating instructions or programs that are stored in the memory 145 to perform various functions for the device 100 and to process data. The processor 105 includes one or more microprocessors, microcontrollers, digital signal processors (DSP), state machines, logic circuitry, or any device or devices that process information based on operational or programming instructions stored in the memory 145. In accordance with the embodiments, the processor 105 processes various functions and data to control an alternative motion-based user interface.

The image output apparatus 110 operates to present images to a user of the device 100 under the control of the processor 105. For example, the images may be received by the image output apparatus 110 from the processor 105 over the communication bus 148. The image output apparatus 110 thus comprises any integrated circuits (ICs), buses and the like necessary to convey data from the processor 105 to the display 115, the projector 120, or both the display 115 and the projector 120. The image output apparatus 110 comprises at least one of the display 115 and the projector 120, and may also comprise both the display 115 and the projector 120.

The display 115 may be realized as an electronic display configured to graphically display information and/or content under the control of the processor 105. Depending on the implementation of the embodiment, the display may be realized as a liquid crystal display (LCD), a touch-sensitive display, a cathode ray tube (CRT), a light emitting diode (LED) display, an organic light emitting diode (OLED) display, a plasma display, a projection display, or another suitable electronic display. The projector 120 may be realized as a digital light processing (DLP) apparatus, employing one or more digital micromirror devices (DMDs) to project an image received from the processor 105 onto a surface external to the device 100. The projector 120 may also be implemented as a laser-based projection device, or a liquid crystal on silicon (LCoS) device.

The motion sensor 125 may be realized as an accelerometer, a gyroscope, or a combination of accelerometers and gyroscopes. The motion sensor 125 is connected to the processor 105 via the communication bus 148 and operates to provide the processor 105 with data describing the movement of the device 100. For example, the data provided to the processor 105 may include a description of a velocity and direction of movement of the device 100, an angle of inclination of the device 100, an acceleration of the device 100, and the like.

The input apparatus 130 operates to receive input from the user of the device 100 and provide that input to the processor 105 via the communication bus 148. The input apparatus 130 may be realized as one or more of a keypad, a touch screen integrated with the display 115 or provided as a separate apparatus from the display 115, a pressure sensor, a microphone, one or more buttons such as a trigger-style button, and the like.

The optical scanner 135 operates to emit light, such as laser light, onto a surface carrying a graphical indicator, such as a barcode, to be decoded. The emission of light by the optical scanner 135 may be initiated, in one embodiment, by actuation of the input apparatus 130 by the user of the device 100. The optical scanner 135 captures the reflected or emitted portion of that light and from the reflected or emitted portion, decodes various types of data from the graphical indicator. The optical scanner operates to provide the decoded data to the processor 105 for further processing.

The camera 145 captures light reflecting from or emitted by objects and surfaces in the vicinity of the device 100, and transmits image data to the processor 105 representing the captured light. The camera 145 thus includes a lens assembly for focusing incoming light, as well as a sensor. The sensor may be realized as an analog sensor, or as a digital sensor such as a charge-coupled device (CCD) sensor or a complementary metal-oxide-semiconductor (CMOS) sensor. In some embodiments, the optical scanner 135 may be a function of the camera 145, rather than a separate hardware component as illustrated in FIG. 1.

The memory 145 may be an IC memory chip containing any form of RAM (random-access memory), a CD-RW (compact disk with read write), a hard disk drive, a DVD-RW (digital versatile disc with read write), a flash memory card, external subscriber identity module (SIM) card or any other non-transitory medium for storing digital information. The memory 145 comprises applications 150, and motion vector rules 155. The applications 150 include various software and/or firmware programs necessary for the operation of the device 100 as well as software and/or firmware programs (e.g. inventory management applications for operating the optical scanner 135 to scan and record boxes, pallets and the like) that address specific requirements of the user of the device 100. In accordance with the embodiments, the device 100 initiates an alternative user interface control process, based on movement of the device 100 and on images presented by the image output apparatus 110, to permit the user of the device to provide input to the applications 150.

The communications interface 147 enables the device 100 to communicate with other devices over local connections (e.g. Bluetooth, local area network) or via a wide area network such as the Internet, mobile networks or a combination thereof. The communications interface 147 may therefore include one or more transmitters, one or more receivers (e.g. an antenna) and any encoding or decoding components for communicating with other devices. Data received at the communications interface may be provided to the processor 105 for further processing via the bus 148, and the processor 105 may provide data to the communications interface 147 over the bus 148 for transmission to another device. Examples of data received at the communications interface 147 and provided to the processor 105 include input data in addition to, or instead of, the data provided by the input apparatus 130; and image data instead of, or in addition to, images retrieved from the memory 145. Data stored in the memory 145 may also be updated via transmissions received at the communications interface 147.

In one embodiment, the device 100 may be used in an inventory management workflow as a scanning device. For example, the user of the device 100 may repeatedly operate the input apparatus 130 to cause the optical scanner 135 to scan and decode a series of barcodes affixed to various objects (e.g. boxes of inventory). The processor 105 may execute the applications 150 to store the decoded barcode data in the memory 145. The inventory management workflow may also branch, or may comprise multiple workflows, such that more than one course of action is available to the user at some points in time. For example, there may be a workflow or branch for scanning items to be loaded for delivery, and another workflow or branch for unloading items from a delivery; it may be necessary or at least desirable to switch between these two workflows or branches when unloading and then loading a delivery vehicle. In another example, at times, it may be necessary for the user of the device 100 to suspend the scanning process and branch to an exception workflow to enter exception data or take some other action. For example, exception data may be required when an actual number of objects does not match the number required to fulfill an order. In this example, the user may be a warehouse worker scanning items and loading them for delivery. If there are not enough items to fulfill a given order, the user may branch to an exception workflow in which the scanning process is interrupted and the user enters the actual quantity of items available (in contrast to the quantity specified by the order) in an exception quantity field. As another example, exception data may be required when the same object was erroneously scanned more than once. In a further example of a branch to an exception workflow, the user of the device 100 may be responsible for loading a vehicle for deliveries by retrieving items, scanning the items and placing them in the vehicle. When the user retrieves an item and determines that that item is intended for a different vehicle, the user may branch to an exception workflow for transmitting an indication from the device 100 informing other system components of the misplaced item. When the above exceptions or other branches have been completed, the device 100 may return to the previous functionality, such as scanning and recording inventory.

In one embodiment, the entry of the device 100 into one of a plurality of alternative workflows or branches of a workflow may be realized by a predefined command provided to the input apparatus 130 by the user. For example, when the input apparatus 130 includes a trigger button for operating the optical scanner 135 as described above, the predefined command may be a long press (e.g. longer than a predefined period of time stored in the memory 145). In other embodiments, the command may be a movement of the device 100 by the user, an audible command captured by the device 100, and the like. In some embodiments, the command may be generated automatically by the device 100 itself upon detection of a predefined condition, such as a location, time of day, duplicate scan, and the like.

In one embodiment, the arrival of the device 100 at a point in a workflow where multiple possible branches or other workflows may be entered into may initiate the alternative user interface control process. During the alternative user interface control process, the device 100 generates an image containing selectable elements and a pointing element. The selectable elements may be menu options retrieved from the applications 150, and the pointing element may be a cursor, a crosshair, or the like. Having generated the image, the device 100 outputs the image through image output apparatus 110. In one embodiment, in which the image output apparatus 110 includes the projector 120, outputting the image comprises projecting the image on a surface in the vicinity of the device 100 using the projector 120. In some embodiments, in which the image output apparatus 110 includes the display 115, outputting the image comprises presenting the image on the display 115. In some of the embodiments in which the image is presented on the display 115, the device 100 may also capture a video feed of an object using the camera 140 and present the image on the display 115 as an overlay on the video feed. Additionally, in some embodiments, outputting the image may comprise a combination of projection using the projector 120 and presentation using the display 115, with or without the video feed. In other embodiments, the pointing element may be transparent so as to be invisible in the projected or displayed image. In still other embodiments, the pointing element may be virtual in that a position of the pointing element is stored by the device 100, but the pointing element is omitted from the image itself.

Having outputted the image, the device 100 detects movement of the device 100 with the motion sensor 125 and updates the image to stabilize the selectable elements against the detected movement and to track the detected movement with the pointing element. Stabilization of the selectable elements against the detected movement by the device 100 comprises manipulating, by the device 100, the selectable elements in the updated image to reduce their apparent motion from the perspective of the user. In other words, stabilization includes reducing or eliminating the effect of the detected movement of the device 100 on the position of the selectable elements in space. Tracking the movement of the device 100 with the pointing element, on the other hand, comprises manipulating, by the device 100, the pointing element in the updated image to follow the movement of the device 100 in space. Therefore the updated image, for example, may include the menu options discussed above, having been relocated within the image to counter the movement of the device 100. The cursor or crosshair discussed above may therefore appear to have moved within the image in relation to the menu options.

The device 100, after generating the updated image, outputs the updated image using the image output apparatus 110. Thus, the updated image replaces the initial image on the image output apparatus 110. The operations performed by the device 100 to update the image and output the updated image depend on the nature of the image output apparatus 110. In one embodiment, in which the image output apparatus 110 comprises the projector 120, updating the image comprises relocating the selectable elements in the updated image to counter the movement of the device 100 (e.g. by rotation, translation and the like, in a direction opposite to a direction of the movement of the device 100). Updating the image also comprises maintaining the location of the pointing element in the updated image. In some embodiments, the image output apparatus comprises the display 115, and updating the image comprises relocating the selectable elements and maintaining the location of the pointing element as discussed above.

In some embodiments, the image output apparatus 110 includes the projector 120, and the projector 120 includes a movable lens. For example, the projector 120 may be coupled to a motor within a housing of the device 100, or the lens only may be coupled to a motor, or the lens may be a liquid lens whose shape changes with varying electrical current applied to the lens. In such embodiments, updating the image may comprise maintaining the location of the selectable elements in the updated image (although the selectable elements may still be skewed or zoomed, for example), and relocating the pointing element in the image to track the movement of the device 100. In such embodiments, outputting the updated image comprises repositioning the lens to counter the movement of the device 100 and projecting the updated image. As a result, the selectable elements (whose locations in the updated image were maintained) remain in place on the projection surface, and the pointing element (whose location in the updated image was altered to track the movement of the device 100) moves along the projection surface to track the movement of the device 100. In other embodiments, stabilization of the selectable elements may be achieved by a combination of relocating the selectable elements in the image and repositioning the projector lens, thus extending the range of motion of the device 100 over which the selectable elements may be stabilized.

Following the output of the updated image, or simultaneously with outputting the updated image, the device 100 determines a motion vector of the pointing element relative to the known positions of the selectable elements. The motion vector describes the motion of the pointing element, across successive updated images, relative to the selectable elements. In some embodiments, the motion vector comprises a direction and velocity of movement of the pointing element relative to the selectable elements. In some embodiments, the motion vector comprises, for a series of updated images, distances between the pointing element and each selectable element (for example, the distances between the pointing element and every edge of each selectable element).

The device 100 compares the motion vector to the rules 155. The rules 155 define conditions that, when met by the motion vector, cause the selection of one of the selectable elements. In some embodiments, the rules specify predefined motion vectors (e.g. angles and velocities) that correspond to specific selectable elements. In some embodiments, the rules specify threshold conditions that do not correspond to specific selectable elements. For example, one such condition may specify that when the motion vector indicates that the pointing element has traversed two opposing edges of a selectable element in a certain time frame, that selectable element is selected (regardless of which selectable element it is).

When the motion vector does not match any of the rules 155, the device 100 continues to detect further movement of the device 100, update the image outputted by the image output apparatus 110, and repeat the determination of a motion vector and the comparison of the motion vector to the rules 155. In some embodiments, during such repetition, the device 100 may monitor the input apparatus 130 to determine whether the predefined command mentioned earlier (e.g. a long press of a trigger button) has been released (i.e. is no longer being applied) or whether a timeout period has elapsed without movement of the pointing element relative to the selectable elements. When the command has been released, the generation and updating of images ceases and the device 100 returns to the operations being performed before initiating the alternative user interface control process.

When, on the other hand, the motion vector does match one of the rules 155, the device 100 selects one of the selectable elements based on the motion vector. In some embodiments, the matched rule itself may specify a particular selectable element. In other embodiments, the rules 155 do not specify particular selectable elements, and the selection is based on which motion vector data resulted in the match. For example, the motion vector may include position data indicating that the pointing element traversed two opposing edges of a specific selectable element, and the rules 155 contain a rule defining “traverse two opposing edges of an element” as a selection event, then the device 100 selects whichever one of the selectable elements was traversed by the pointing element.

In response to the selection of a selectable element, the device 100 performs an action corresponding to the selected one of the selectable elements. For example, the action may be to present a menu with the image output apparatus 110, to launch another one of the applications 150, or the like. As discussed in the examples of workflow branches above, the action may be to present an exception quantity field and a number pad or keypad allowing the user of the device 100 to enter a number or other data into the field. Following the performance of the action corresponding to the selected one of the selectable elements, and optionally the performance of additional actions, the device 100 may return to the previous user interface, such as the user interface employed to scan items and record the scanned data in the memory 145. The return to a previous user interface, however, may be omitted in some embodiments. For example, in the inventory management examples discussed above, the entry of exception data or other workflow branching by the user may be deferred until all other items have been scanned, in which case it may not be necessary to return to the previous user interface for scanning items.

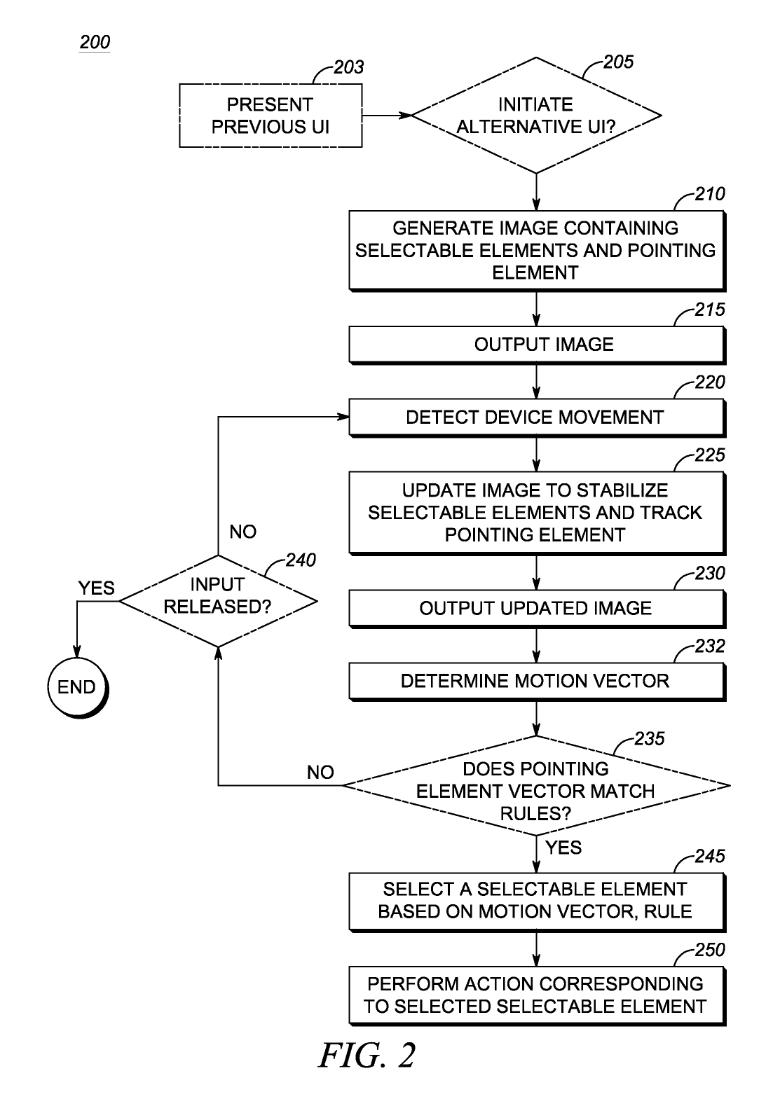

FIG. 2 represents a flowchart of a method 200 for controlling an alternative motion-based user interface in the device 100 of FIG. 1 in accordance with some embodiments. As illustrated in FIG. 2, the method 200 begins at block 203 by presenting a previous user interface. The previous user interface may include the presentation of any of a variety of images, including menu options, fields and the like, on the display 115. For example, the previous user interface may include presenting an image on the display 115 showing the decoded contents of scanned barcodes. In other embodiments in which the device 100 does not include the display 115, the previous user interface may involve the device 100 being configured to interpret a certain input (e.g. a trigger button press) as a scanning command. At block 205, the device 100 may optionally determine whether to initiate the alternative user interface control process. The determination at block 205 may include receiving an input at the processor 105 via the input apparatus 130 to initiate the alternative user interface control process. The input received at block 205 may be, for example, a long press of a trigger button, a voice command, a motion of the device 100 by the user, a predetermined sequence of key presses on a keypad, and the like. The determination at block 205 may also include, in other embodiments, input in the form of an instruction received at the processor 105 via the communications interface 147. In addition, the determination at block 205 may include a determination to initiate any one of a plurality of different alternative user interfaces. For example, each one of a plurality of different inputs detected at block 205 may lead to a different alternative user interface. Optionally, the device 100 may determine automatically which one of a plurality of alternative user interfaces to present following an affirmative determination at block 205.

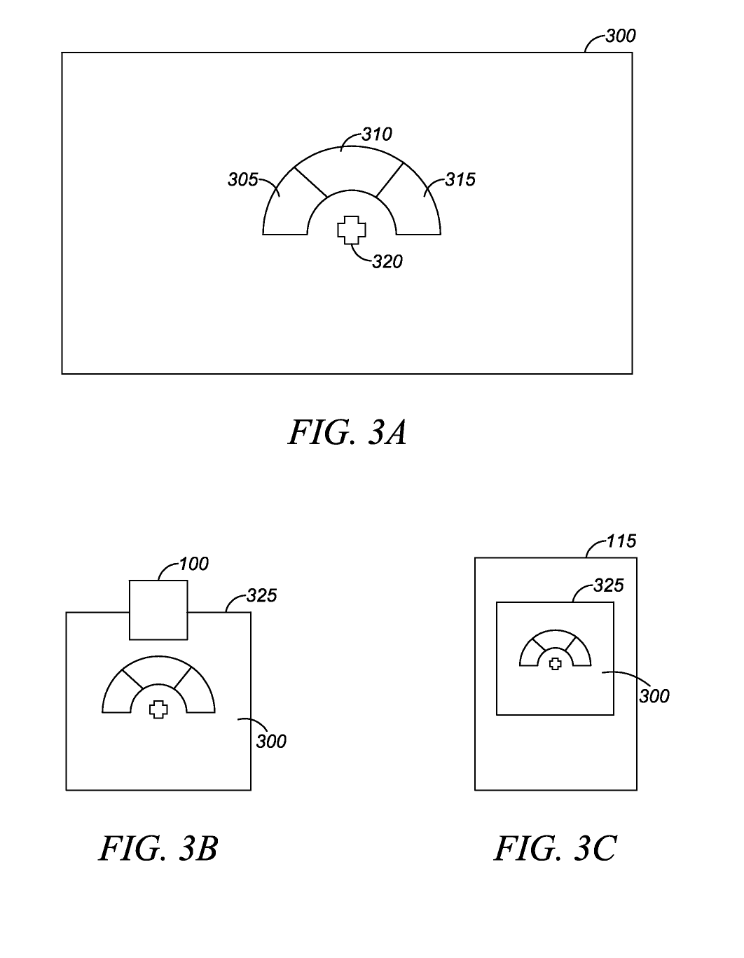

At block 210, the device 100 generates an image containing a plurality of selectable elements and a pointing element. The selectable elements and the pointing element may be contained within the data defining the applications 150. For example, in some embodiments, the application being executed at the time of the input received at block 205 may contain various menus comprising selectable elements (e.g. menu options) and the device 100 may select the elements of one of those menus at block 210. In some embodiments, the device 100 may execute a different one of the applications 150 to retrieve the selectable elements and pointing element from the memory 145, or may receive the selectable elements and pointing element via the communications interface 147. In some embodiments, the selectable elements and the pointing element may be selected from a number of possible sets of selectable elements and pointing elements. The selection may be based on, for example, the current context of use of the device 100 (e.g. whether the device 100 is being used to scan inventory for shipping or receiving), the time of day, a location of the device 100, and the like. The image generated at block 210 contains the selectable elements and the pointing element in predetermined default positions, for example centered in the image. FIG. 3A depicts an example of an image 300 generated at block 210 according to some embodiments. The image 300 contains three selectable elements 305, 310 and 315 disposed in a radial arrangement, and a pointing element 320 in the form of a crosshair. In other embodiments, the pointing element 320 may be transparent so as to not appear in the projected or displayed image, or may be omitted from the image entirely, although a position of where the pointing element would appear if it were rendered may be tracked in the memory 145.

Referring back to FIG. 2, at block 215, the device 100 outputs the image generated at block 210 using the image output apparatus 110. In some embodiments, as shown in FIG. 3B, block 215 comprises projecting the image using the projector 120. In FIG. 3B, the image 300 is projected onto a surface of a box 325 or other object from the device 100, which is held in front of the box 325. In some embodiments, as shown in FIG. 3C, the image 300 is presented on the display 115, in addition to or instead of being projected on the box 325. In such embodiments, a video feed of the box 325 may be captured by the device 100 using the camera 140, and the video feed may be presented on the display 115 in the background of the image 300. Thus, in FIG. 3C, the box 325 is visible on the display 115.

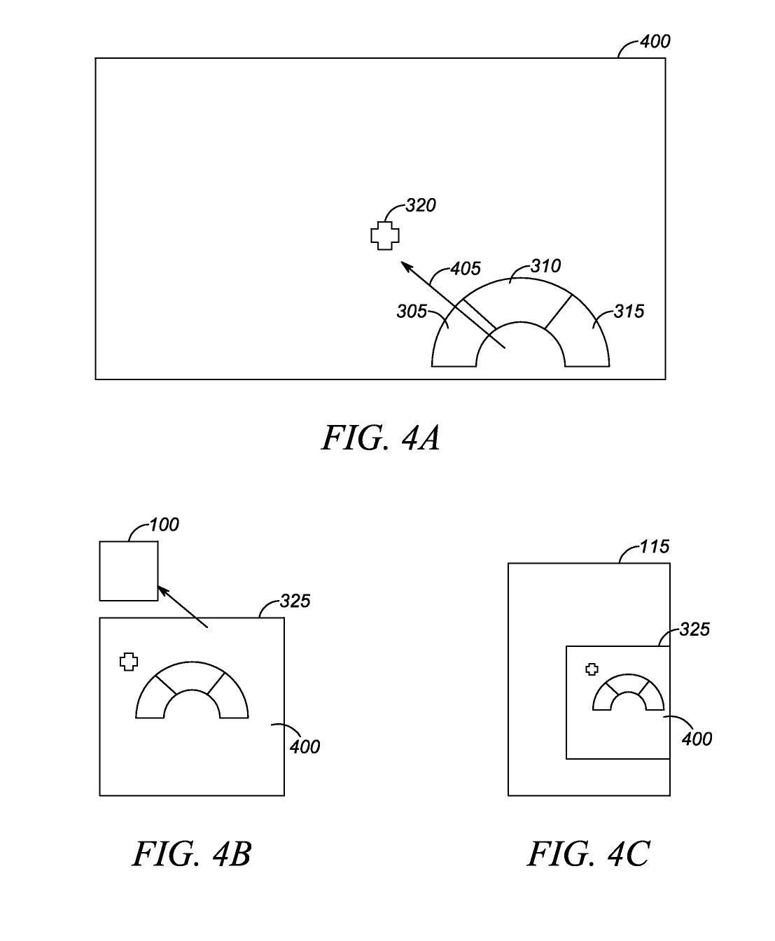

Returning to FIG. 2, at block 220 the device 100 detects movement of the device 100. For example, movement may be detected by monitoring data received at the processor 105 from the motion sensor 125. FIG. 4B shows the device 100 as having moved upwards and to the left, in relation to the box 325, by the user.

At block 225 of FIG. 2, the device 100 updates the image to stabilize the plurality of selectable elements against the detected movement and to track the detected movement with the pointing element. The device 100, to stabilize the selectable elements against the detected movement, may manipulate the selectable elements in the updated image to reduce or eliminate their apparent motion from the perspective of the user. For example, as shown in FIG. 4A, the device 100 may generate an updated image 400 in which the selectable elements 305, 310 and 315 have been translated downwards and to the right, in a direction opposite to the movement of the device 100 shown in FIG. 4B. Various other transformations may also be applied to the selectable elements 305, 310 and 315, including rotation to counter tilting of the device 100, skewing to counter rotation of the device 100, zooming in or out to counter movement of the device 100 closer and farther to the box 325, and the like.

The device 100 may also, to track the detected movement with the pointing element 320, maintain the original location of the pointing element in the image. As shown in FIG. 4A, the pointing element 320 appears in the same position in the image 400 as in the image 300. Some alterations may be made to the position of the pointing element 320. For example, the pointing element 320 may be relocated to eliminate jitter (e.g. device movements that fall below a predefined threshold). In some embodiments, the motion sensor 125 may include a first motion sensor to detect gross device movement used to update the location of the selectable elements in the image, and a second motion sensor to detect jitter used to update the location of the pointing element. As mentioned earlier, in embodiments in which the image output apparatus 110 includes the projector 120 with a moveable lens, the above-mentioned transformations are reversed (e.g. the selectable elements are maintained in the same position, while the pointing element is relocated in line with the movement detected by the device 100). In some embodiments, movement of the device 100 may be detected by the device 100 using two or more different motion sensors, and the movement from a first motion sensor may be used to stabilize the selectable elements while the movement from a second motion sensor may be used to track the movement with the pointing element. In some embodiments, movement of the device 100 may also be detected using the camera 140, instead of or in addition to the above-mentioned motion sensors.

At block 230 of FIG. 2, the device 100 outputs the updated image using the image output apparatus 110. FIGS. 4B and 4C illustrate the performance of block 230 according to some embodiments. In FIG. 4B, the device 100 has projected the image 400 onto the box 325. As seen by comparing FIGS. 3B and 4B, the selectable elements 305, 310 and 315 have not moved on the surface of the box 325 (i.e. they have been stabilized against the detected movement of the device 100), while the pointing element 320 appears in a different location on the box 325, having shifted to track the movement of the device 100. As seen by comparing FIGS. 3C and 4C, the selectable elements 305, 310 and 315 appear in the same position over the video feed of the box 325 (which has moved due to the movement of the device 100). The pointing element 320, meanwhile, appears in the same position on the display 115, but is in a different location relative to the selectable elements as a result of their relocation.

At block 232 of FIG. 2, having output the updated image, the device 100 operates to determine a motion vector of the pointing element relative to the selectable elements within the image and the updated image. The motion vector describes the changes in position of the pointing element relative to the selectable elements from the initial image to the updated image, and to subsequent updated images. In some embodiments, the motion vector comprises a direction and velocity of movement of the pointing element relative to the selectable elements. In some embodiments, the motion vector comprises, for a series of updated images, distances between the pointing element and each selectable element (for example, the distances between the pointing element and every edge of each selectable element). Referring to FIG. 4A, a visual representation of a motion vector 405 is shown. It will be understood that the motion vector 405 is not a part of the image 400. The motion vector 405 may be represented in a variety of ways. For example, the device 100 may compute the motion vector 405 as having a certain angle and magnitude (e.g. velocity). In other embodiments, the device 100 may compute the motion vector 405 as a series of distances between the pointing element 320 and various features (such as edges) of each of the selectable elements 305, 310 and 315. The performance of block 232 may be simultaneous with either of blocks 225 and 230, or may occur subsequently to either of blocks 225 and 230.

At block 235, the device 100 operates to compare the motion vector to the rules 155 stored in the memory 150 and determine whether the motion vector matches any of the rules 155. As mentioned earlier, the rules 155 define various conditions to be met by the motion vector for causing some further action to be taken by the device 100. In some embodiments, the rules specify predefined motion vectors (e.g. angles and velocities) that correspond to specific selectable elements. In other embodiments, the rules specify threshold conditions, such as a requirement that the motion vector traverses two opposing edges of a selectable element in a certain period of time. Another example of such a condition is a requirement that the motion vector remain within a certain distance of the center of a selectable element for a period of time. In some embodiments, where a long press of a trigger button causes the initiation of the alternative user interface control process, an example condition may be a requirement that the motion vector end within the boundaries of a selectable element when the long press is released.

When the determination at block 235 is negative (that is, when the motion vector does not match any of the rules 155) the performance of the method 200 proceeds, optionally, to block 240 and then returns to block 220 to continue monitoring for device movement. At block 240, the device 100 determines whether the input (optionally) received at block 205 has been released, or whether a timeout period has elapsed without movement of the pointing element relative to the selectable elements. In some embodiments, the device 100 may alternatively determine at block 240 whether the device 100 has moved to such an extent that the object originally in the field of view of the projector 120 or the camera 140 is no longer in that field of view. Thus, for example, the determination at block 240 may be whether the trigger button depressed at block 205 has been released. When the input has been released, the performance of method 200 ends and the device 100 returns to the function being performed before method 200 began. Otherwise, the device 100 proceeds to repeat blocks 220, 225, 230 and 235.

When the determination at block 235 is affirmative (that is, when the motion vector does match one of the rules 155), the device 100 proceeds to block 245, shown in FIG. 2. At block 245, the device 100 operates to select one of the selectable elements based on the motion vector and the matching rule. In some embodiments, the matched rule itself may specify a particular selectable element. For example, one of the rules 155 may specify that the motion vector 405 shown in FIG. 4A corresponds to the selectable element 305. In other embodiments, the rules 155 do not specify particular selectable elements, and the selection is based on which motion vector data resulted in the match. For example, the motion vector 405 shows that the pointing element has “travelled” relative to the selectable elements to traverse two opposing edges of the selectable element 305. One of the rules 155 may define “traverse two opposing edges of an element” as a selection event, in which case the device 100 selects the selectable element 305, since that is the selectable element that, in conjunction with the motion vector 405, matched the rule. The selectable elements 310 and 315 would not be selected in this example, as the motion vector 405 does not traverse any of their edges.

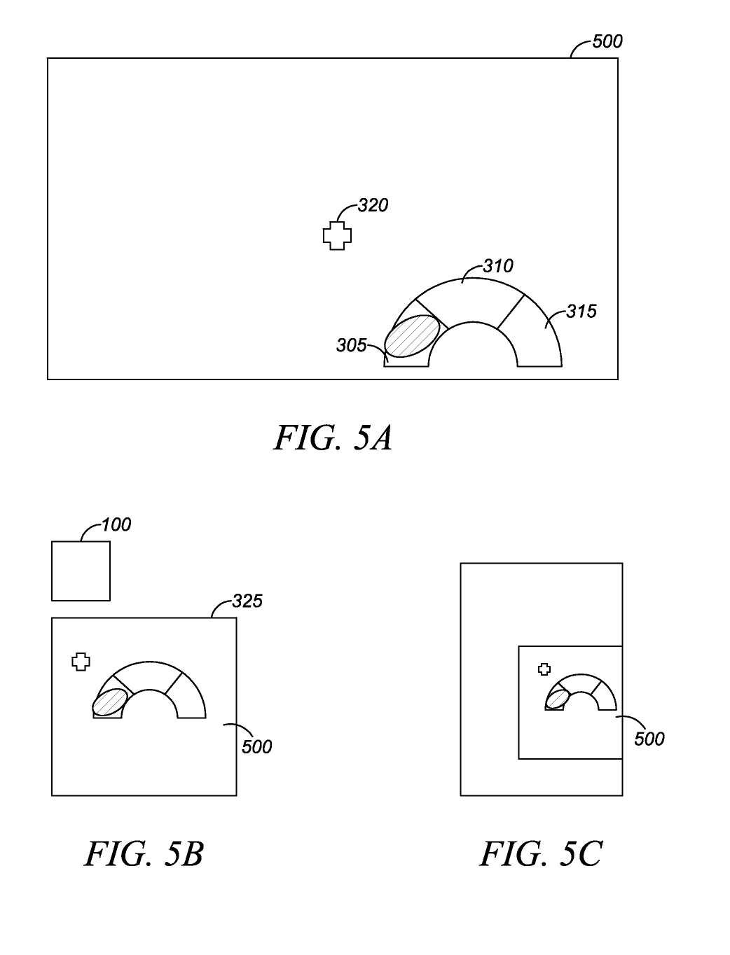

At block 250, in response to the selection of a selectable element at block 245, the device 100 performs an action corresponding to the selected one of the selectable elements. For example, the action may be to present a menu with the image output apparatus 110, to launch another one of the applications 150, or the like. The device 100 may also conduct a final update to the image prior to performing the action, as shown in FIGS. 5A, 5B and 5C, in which a further updated image 500 has been generated to show the selectable element 305 as being filled in or otherwise distinguished visually to indicate its selection. Following the performance of the action at block 250, and optionally following the performance of one or more subsequent actions, the device 100 may return to a previous user interface, such as that presented at block 203. In some embodiments, the selectable element may be a “cancel” or “return” element, and thus the action performed following its selection may be to return to the previous user interface. In other embodiments, however, the return to a previous user interface may be omitted.

Accordingly, various embodiments described above may be advantageously implemented on devices to provide and control alternative motion-based user interfaces. Embodiments of the present disclosure describe several ways in which the device may present an alternative user interface in order to provide ready access to certain applications or functions of the device. The embodiments described above allow alternative workflows to be handled with minimal additional input by the user, avoiding the need to back out of applications or navigate through various levels of menus. The embodiments also allow the device to accept input in a manner that closely mimics the function previously being performed by the device (e.g. scanning inventory), further reducing the time lost to the switch between alternative workflows. In addition, the embodiments allow for control of the device using relatively small gestures by a user, and provide a control mechanism that may be applied with little or no modification to a variety of different menus of selectable elements.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for controlling an alternative motion-based user interface in a device comprising a projector, the method comprising:
receiving, at the device, an input comprising an instruction to switch from a previous user interface to the alternative user interface;
generating, by the device, an image containing a plurality of selectable elements and a pointing element;
projecting the image on a surface with the projector;
detecting, by the device, a movement of the device;
updating, by the device, the image to stabilize the plurality of selectable elements against the detected movement and to track the detected movement with the pointing element;
projecting the updated image on the surface;
selecting, by the device, one of the selectable elements based on a motion vector of the pointing element relative to the selectable elements;
performing an action at the device corresponding to the selected one of the selectable elements.

2. The method of claim 1, wherein the selectable elements further comprise menu options.

3. The method of claim 1, wherein the pointing element further comprises one of a cursor and a crosshair.

4. The method of claim 1, wherein detecting movement of the device further comprises detecting the movement with one of a camera and a motion sensor, and wherein the motion sensor further comprises at least one of a gyroscope and an accelerometer.

5. The method of claim 1, wherein updating the image further comprises:
relocating the selectable elements to counter the detected movement, and maintaining a location of the pointing element.

6. The method of claim 1, wherein updating the image further comprises:
relocating the pointing element to counter the detected movement, and maintaining a location of the selectable elements; and
wherein projecting the updated image further comprises repositioning a lens of the projector to counter the detected movement.

7. The method of claim 6, wherein repositioning the lens comprises controlling a motor, by the device, to reposition the projector to counter the detected movement.

8. The method of claim 6, wherein the lens comprises a liquid lens, and wherein repositioning the lens comprises controlling the liquid lens, by the device, to redirect the updated image to counter the detected movement.

9. The method of claim 1, further comprising detecting a user input at an input apparatus of the device prior to generating the image.

10. The method of claim 9, wherein the input apparatus includes a trigger button and wherein the user input comprises a long press of the trigger button.

11. The method of claim 1, wherein detecting the movement of the device further comprises detecting the movement with at least a first motion sensor and a second motion sensor different from the first motion sensor; and
wherein updating the image further comprises stabilizing the plurality of selectable elements against the movement detected by the first motion sensor, and tracking the movement detected by the second motion sensor with the pointing element.

12. A method for controlling an alternative motion-based user interface in a device comprising a camera and a display, the method comprising:
receiving, at the device, an input comprising an instruction to switch from a previous user interface to the alternative user interface;
capturing, with the camera, a video feed of a surface;
generating, by the device, an image containing a plurality of selectable elements and a pointing element;
presenting the image on the display overlaid on the video feed;
detecting, by the device, movement of the device;
updating, by the device, the image to stabilize the plurality of selectable elements against the detected movement and to track the detected movement with the pointing element;
presenting the updated image on the display overlaid on the video feed;
selecting, by the device, one of the selectable elements based on a motion vector of the pointing element relative to the selectable elements;
performing an action at the device corresponding to the selected one of the selectable elements.

13. The method of claim 12, wherein the selectable elements further comprise menu options.

14. The method of claim 12, wherein the pointing element further comprises one of a cursor and a crosshair.

15. The method of claim 12, wherein detecting movement of the device further comprises detecting the movement with a motion sensor, and wherein the motion sensor further comprises one of a gyroscope and an accelerometer.

16. The method of claim 12, wherein updating the image further comprises:
relocating the selectable elements in a direction opposite to a direction of the detected movement, and maintaining a location of the pointing element.

17. A device, comprising:
an image output apparatus;
a processor connected to the image output apparatus and operated to:
receive an input comprising an instruction to switch from a previous user interface to an alternative user interface;
generate an image containing a plurality of selectable elements and a pointing element;
control the image output apparatus to output the image;
detect a movement of the device;
update the image to stabilize the plurality of selectable elements against the detected movement and to track the detected movement with the pointing element;
control the image output apparatus to output the updated image;
select one of the selectable elements based on a motion vector of the pointing element relative to the selectable elements;
perform an action corresponding to the selected one of the selectable elements.

18. The device of claim 17, wherein the image output apparatus further comprises a projector.

19. The device of claim 17, wherein the image output apparatus further comprises a display.

20. The device of claim 17, wherein the selectable elements further comprise menu options and wherein the pointing element further comprises one of a cursor and a crosshair.
